(19) United States
(12) Patent Application Publication
(10) Pub. No.: US 2026/0225212 A1
(43) Pub. Date: Aug. 6, 2026

(54) Pressing Tool

(71) Applicant: Novopress GmbH und Presswerkzeuge & Co. KG, Neuss (DE)

(72) Inventors: Stephan Krämer, Oberhausen (DE); Martin Bungter, Mönchengladbach (DE)

(21) Appl. No.: 19/147,350

(22) PCT Filed: Jan. 12, 2024
(86) PCT No.: PCT/EP2024/050664

§ 371 Date: Jul. 11, 2025

(30) Foreign Application Priority Data
Jan. 13, 2023 (DE) 10 2023 100 782.3

(51) Int. Cl. B25B 27/10

(52) U.S. Cl. CPC B25B 27/10

(57) ABSTRACT

A pressing tool, in particular for pressing a workpiece by means of a pressing device, having at least two segments movably connected to one another. A first segment and a last segment each have a receptacle for receiving a connection element of a pressing device, wherein at least one receptacle has a receptacle edge which delimits the receptacle, wherein a deflector is arranged on the receptacle, so that the connection element is deflected from the receptacle edge.

### CROSS-REFERENCE TO RELATED APPLICATIONS

This application is the United States national phase of International Patent Application No. PCT/EP 2024/050664 filed Jan. 12, 2024, and claims priority to German Patent Application No. 10 2023 100 782.3 filed Jan. 13, 2023, the disclosures of which are hereby incorporated by reference in their entireties.

### BACKGROUND OF THE INVENTION

### Field of the Invention

The present invention relates to a pressing tool, in particular for pressing a workpiece by means of a pressing device.

### Description of Related Art

Electric or electro-hydraulic pressing devices are used to connect workpieces and in particular pipes. The workpieces are connected, for example, using a press fitting to be pressed. For this purpose, a pressing tool is placed around the press fitting or the workpiece. The pressing tool can have two or more segments movably connected to one another. In particular, the pressing tool can be formed as press rings or as a press collar. The pressing tool has receptacles into which the connection elements of the pressing device and, in particular, the pressing jaws of the pressing device can engage in order to thus transfer the pressing force of the pressing device to the pressing tool. The press fitting or the workpiece is pressed by reducing the circumference of the pressing tool. The receptacle can be formed as a ball socket or spherical recess, for example, so that a spherical connection element of the pressing device can be received in the receptacle. Nonetheless, hooks and bolts are also known as interfaces. However, the ball and ball socket have the advantage that the pressing tool and the pressing device can be pivoted towards each other.

If the connection element has been correctly inserted into the receptacle, there is a full-surface transfer of force from the pressing device to the pressing tool. This ensures that neither the pressing tool nor the pressing device is damaged when high force is applied.

However, if the connection element is not correctly inserted into the receptacle of the pressing tool, but rests on an edge of the receptacle, correct pressing cannot be guaranteed. In many cases, the connection element of the pressing device slips off the pressing tool or into the receptacle, depending on the starting position. In some cases, however, the entire closing force of the pressing device is built up on the receptacle edge. This is known as a point load situation. In a point load situation, the connection element of the pressing device is placed directly on the receptacle edge of the receptacle of the pressing tool without slipping when the closing force is applied. This causes damage to the receptacle edge and the connection element of the pressing device. The pressing device and pressing tool can therefore no longer be used. In extreme cases, the pressing tool can slip and fly off in an uncontrolled manner, which can endanger the operator. Smaller metal splinters from the receptacle edge can also break off and be thrown away by the present forces, so there is also a potential for injury. Such situations cannot always be avoided in practice. Such scenarios can easily arise, particularly in tight installation situations, in poor lighting conditions or if the operator is unable to sufficiently support the pressing device.

The object of the present invention is to ensure safe operation of the pressing tool.

The object is achieved by a pressing tool as described herein.

### SUMMARY OF THE INVENTION

The present invention relates to a pressing tool, in particular for pressing a workpiece such as a press fitting or a pipe by means of a pressing device. The pressing tool has at least two segments movably connected to one another, wherein a first segment and a last segment each have a receptacle for receiving a connection element of a pressing device. By connecting the respective connection element of the pressing device to the corresponding receptacle of the pressing tool, force can be transmitted from the closing pressing jaws of the pressing device to the pressing tool. Here, at least one receptacle, and in particular both receptacles, has a receptacle edge which delimits the receptacle. In normal operation, the connection element of the pressing tool must be pushed over the receptacle edge in order to be correctly received in the receptacle.

According to the invention, a deflector is arranged on the at least one receptacle so that the connection element is deflected from the receptacle edge when a closing force is applied. In this case, the connection element can be deflected in such a way that it is guided into the receptacle or away from the receptacle. This takes place in particular depending on the initial position of the connection element relative to the receptacle edge or relative to the deflector, respectively. If the connection element is not correctly connected to the receptacle of the pressing tool, the connection element comes into contact with the deflector of the pressing tool and is deflected by the deflector from the receptacle edge, so that a point load or point load situation cannot occur on the receptacle edge and the pressing tool cannot be damaged or even destroyed by the application of the closing force.

Preferably, the at least one receptacle is at least partially formed as a spherical recess for receiving an at least partially spherical connection element.

Preferably, the at least one receptacle has a shape that is congruent with the connection element of the pressing device.

Preferably, both receptacles of the pressing tool have the same design.

Preferably, deflectors are respectively arranged on both receptacles. Here, the deflectors can have the same or different designs.

Preferably, the pressing tool has a plurality segments connected to one another in a chain-like manner. In particular, the pressing tool is formed as a press collar.

Preferably, the pressing tool has exactly two segments movably connected to one another. In particular, the pressing tool is formed as a press ring.

Preferably, the deflector is made of a different material than the segments. By selecting the material of the deflector, its function can be selected accordingly. In particular, the deflector does not have to be configured to transfer forces from the pressing device to the pressing tool.

The deflector is preferably made of rubber or plastic. Compared to the metal of the segments, this is a relatively soft material, so that the deflector is easily deformed if the connection element is placed on the deflector and a closing force is applied. In particular, this can prevent damage to the connection element of the pressing device. Due to the deformation of the deflector, the connection element of the pressing device is deflected from the receptacle edge.

Preferably, the deflector is less hard than the connection element of the pressing device. This ensures that even if the pressing device is placed incorrectly on the pressing tool and the connection element comes into contact with the deflector, only the deflector is damaged or deformed and the connection elements of the pressing device remain undamaged.

Preferably, the deflector is plastically or elastically deformable. Thus, the deformability of the deflector can affect the entire deflector if it is made of rubber or plastic, for example. Alternatively, the deformability can also only affect parts of the deflector, such as a deflector edge that comes into contact with the connection element of the pressing device. Due to the deformation of the deflector, the connection element of the pressing device is deflected from the receptacle edge.

Preferably, the deflector is molded, glued, screwed or clamped to the first and/or last segment. On the one hand, this ensures a secure connection between the deflector and the respective segment.

Preferably, the deflector can be configured to be detachable and in particular replace-able, so that it can be replaced if the deflector is damaged in order to continue to ensure safe operation of the pressing tool.

Preferably, the deflector has a deflector edge with which the connection element of the pressing device can come into contact and as a result of which the connection element is deflected from the receptacle edge into the receptacle if the contact point of the connection element, starting from the receptacle, is located in front of the deflector edge and is deflected from the pressing tool, provided that the contact point of the connection element, starting from the receptacle, is located behind the deflector edge.

Preferably, a line of action is located between the deflector edge of the first segment and a center of the receptacle of the last segment (or vice versa) below the receptacle edge. The line of action describes the direction of the force applied when the pressing jaws of the pressing device close and, in particular, the direction of the force applied to the pressing tool. Here, below defines that the line of action is behind the receptacle edge, starting from the receptacle. This ensures that the connection element comes into contact with a part of the pressing tool that is not the receptacle edge of the receptacle and is therefore deflected from the receptacle. This prevents a point load situation in which the connection element rests directly on the receptacle edge, resulting in damage.

Preferably, the deflector is adapted to be displaced, in particular in the direction of the pressing movement of the pressing device or in the closing direction of the pressing tool. This allows the deflector to be displaced when the connection element is placed on the deflector, thus deflecting the connection element away from the recess of the pressing tool without resulting in a point load situation.

Preferably, the deflector is arranged directly adjacent to the receptacle edge. This ensures that the connection element of the pressing tool is either placed on the deflector or inserted correctly into the receptacle.

Preferably, one surface of the deflector is aligned with an inner surface of the receptacle. This ensures that when the connection element is deflected by the deflector, it can slide correctly into the receptacle via the aligned surfaces of the deflector and the receptacle.

Preferably, the deflector edge or the deflector protrudes transversely beyond the receptacle edge. Transversely refers to the direction opposite to the closing movement of the pressing tool and coincides, for example, with the direction of the opening of the receptacles for receiving the connection elements. This ensures that the connection element either comes into contact with the deflector as the deflector protrudes transversely beyond the receptacle edge, or that the connection element is correctly inserted into the receptacle.

Preferably, the receptacle edge has a chamfer pointing away from the receptacle. In particular, the surface normal of the chamfer points away from the receptacle. The chamfer ensures that the connection element is deflected if the connection element comes into contact with the chamfer of the receptacle edge.

In particular, the chamfer can be covered by the deflector. This means that if the connection element is not inserted correctly into the receptacle, the deflector can be plastically or elastically deformed in such a way that the connection element comes into contact with the chamfer and is thus deflected from the receptacle. Alternatively, the deflector is adapted to be displaced as described above, so that the force of the connection element displaces the deflector and thus the connection element comes into contact with the phase of the receptacle and is deflected therefrom. As the phase is a surface, no point load situation can arise and, in particular, damage to the connection element and/or the pressing tool is impossible.

The deflector is preferably indicated in color. In particular, the deflector color-codes a nominal width of the pressing tool. In the event that the deflector is an additional rubber or plastic part that is molded, glued, screwed or clamped to the pressing tool, the deflector can easily be used to color-code the nominal width of the pressing tool to ensure that the pressing tool is always used with the correct pressing jaw of the pressing device.

In another embodiment of the present invention, a pressing tool is provided, in particular for pressing a workpiece by means of a pressing device. The pressing tool has at least two segments movably connected to one another, wherein a first segment and a last segment each have a receptacle for receiving a connection element of a pressing device. By connecting the respective connection element of the pressing device to the corresponding receptacle of the pressing tool, force can be transmitted from the closing pressing jaws of the pressing device to the pressing tool. Here, at least one receptacle, and in particular both receptacles, has a receptacle edge which delimits the receptacle. In normal operation, the connection element of the pressing tool must be pushed over the receptacle edge in order to be correctly received in the receptacle.

According to the invention, the receptacle edge is adapted to be deformed by the pressing device, wherein the connection element is deflected from the receptacle edge by the deformed receptacle edge. This means that if the pressing device is placed incorrectly on the pressing tool, only the pressing tool will be damaged. The pressing device and, in particular, the pressing jaws of the pressing device remain undamaged, as the receptacle edge is deformed by the closing force of the pressing jaws and the connection element is deflected from the receptacle edge of the pressing tool.

Preferably, the force for deforming the receptacle edge is less than a force for damaging the connection element of the pressing device.

Furthermore, the pressing tool is configured in accordance with the features of the pressing tool described above.

### BRIEF DESCRIPTION OF THE DRAWINGS

The terms Fig., Figs., Figure, and Figures are used interchangeably in the specification to refer to the corresponding figures in the drawings.

In the following, the invention is described in more detail by means of preferred embodiments with reference to the accompanying figures.

FIGS. 1A-1C show a pressing tool from prior art with pressing jaws of a pressing device,

FIGS. 2A-2C show an embodiment of the present invention,

FIG. 3 shows another embodiment of the present invention, and

FIG. 4 shows another embodiment of the present invention,

### DESCRIPTION OF THE INVENTION

In the following figures, the same or similar components are marked with the same reference numerals.

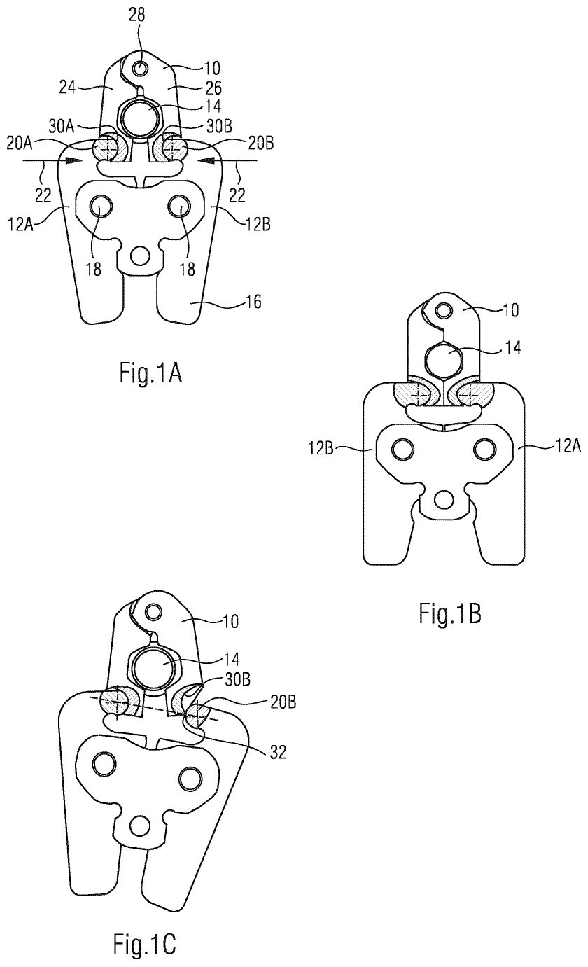

Reference is made hereinafter to FIGS. 1A to 1C. In these figures, a pressing tool 10 is shown, which is connected to the pressing jaws 12A, 12B for pressing a press fitting 14. For this purpose, the pressing jaws 12A, 12B are pressed apart at the lower end 16 by a drive of a pressing device (not illustrated), so that the pressing jaws 12A, 12B are pivoted about pivot axes 18 and the connection elements 20A, 20B opposite the lower end 16 are moved towards each other in a closing movement in accordance with the arrows 22.

The pressing tool 10 has a first segment 24 and a second segment 26 which are movably connected to one another, for example by means of a bolt 28. In the following embodiments of the figures, the pressing tool is shown as a press ring with only 2 segments. However, the present invention is not limited thereto and the pressing tool 10 can have more than two segments, which are connected to each other in a chain-like manner and thereby form a press collar. A first receptacle 30A, which is formed as a spherical recess, is arranged with the first segment 24. The first connection element 20A of the pressing device can be positively inserted into this first receptacle 30A for force transmission. The second segment 26 of the pressing tool 10 also has a second receptacle 30B, into which a second connection element 20B of the pressing device can also be positively inserted. The closing movement of the pressing jaws 12A, 12B reduces an internal radius of the pressing tool 10, whereby the workpiece 14 or the press fitting is pressed. This is illustrated in FIG. 1B.

FIG. 1C shows the situation in which the second connection element 20B has not been fully inserted into the second receptacle 30B of the pressing tool. Rather, the second connection element 20B rests on a receptacle edge 32. In prior art, this can lead to a situation where the second connection element 20B slips into the receptacle 30B or slips off the pressing tool 10 when a closing force is applied. This is done depending on the contact point between the receptacle edge 32 and the second connection element 20B. Alternatively, a point load situation may occur. In a point load situation, the connection element of the pressing device is placed directly on the receptacle edge of the receptacle of the pressing tool. This prevents the pressing device from slipping off the pressing tool or the receptacle edge 32 when a closing force is applied. Rather, the entire closing force of the second connection element 20B is applied to the receptacle edge 32. This results in high forces, which can irreversibly damage both the pressing tool 10 and the pressing device and, in particular, the connection element 20B of the pressing device, making it unusable.

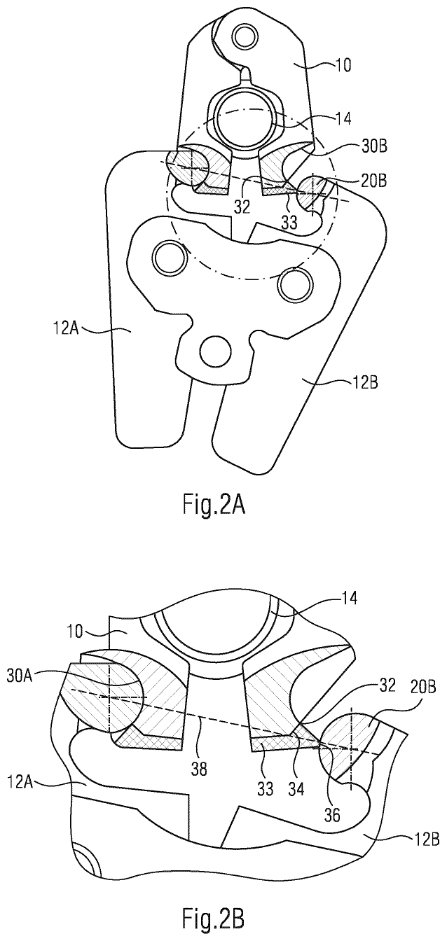

Reference is made hereinafter to FIGS. 2A-2C, which show an embodiment of the present invention. FIG. 2A again shows the situation where the second connection element 20B of the pressing device has not been correctly inserted into the second receptacle 30B. According to the present invention, however, a deflector 33 is arranged on the receptacle edge 32, which projects laterally or transversely beyond the receptacle edge 32. Thus, the second connection element 20B with the deflector 33 and in particular a deflector edge 36 comes into a grip. The connection element 20B is now either deflected by the deflector into the receptacle 30B or also slips off the pressing tool. In particular, however, the deflector 33 is made of a soft material such as plastic or rubber, so that slipping off or sliding into the receptacle 30B occurs even with small closing forces, so that neither damage to the pressing tool 10 nor damage to the pressing device can occur. At the same time, this also significantly reduces the risk of injury to the operator. However, if there is a point load situation on the deflector edge 36, so that the second connection element 20B does not slip off the deflector 33 and in particular the deflector edge 36, the deflector 33 deforms as shown in FIG. 2C. The second connection element 20B comes into contact with a chamfer 34 of the receptacle edge 32 and is deflected from the pressing tool 10 by the latter, without excessive force being exerted on either the pressing tool 10 or the connection element 20B of the pressing device. For this purpose, the chamfer 34 has a chamfer surface pointing away from the respective receptacle 30A, 30B. Here, in particular, the deflector 33 covers the chamfer 34 of the receptacle edge 32 and only when the deflector 33 is deformed, as shown in FIG. 2C, does the second connection element 20B come into contact with the chamfer 34.

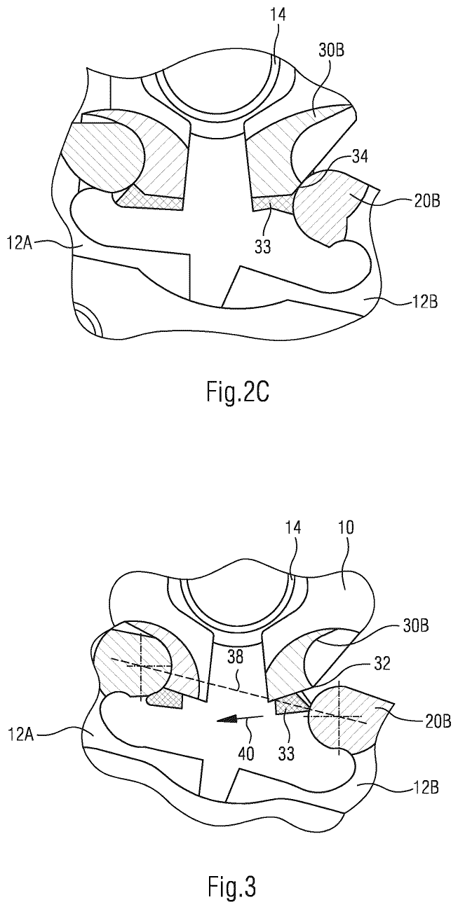

Even in the point load situation shown in FIG. 2B, it is ensured in any case that a line of action 38 is located below the receptacle edge 32. The line of action 38 describes the direction of the force applied during a closing movement and connects the two connection elements 20A, 20B of the pressing device. Particularly in a point load situation, the line of action passes directly through the deflector edge 36 and the center of the first receptacle 30A. As can be seen in FIG. 2B, the line of action 38 passes below the receptacle edge 32. The effect of the closing force on the deflector 33 and subsequent deformation (or displacement as shown in FIG. 3) results in that the second connection element 20B can no longer come into contact with the receptacle edge 32. This can prevent a point load situation caused by the second connection element 20B resting on the receptacle edge 32 of the pressing tool 10, and the pressing device slips off the press ring 10.

In the following, reference is made to the embodiment of FIG. 3. In this embodiment, the deflector 33 is displaceable in accordance with the arrow 40. In this case, the line of action 38 is also located below the receptacle edge 32, i.e. starting from the second receptacle 30B behind the receptacle edge 32. If the second connection element 20B thus comes into contact with the underside of the pressing tool, the second connection element 20B is deflected from the pressing tool and in particular from the second receptacle 30B. This cannot result in a point load situation on the receptacle edge 32.

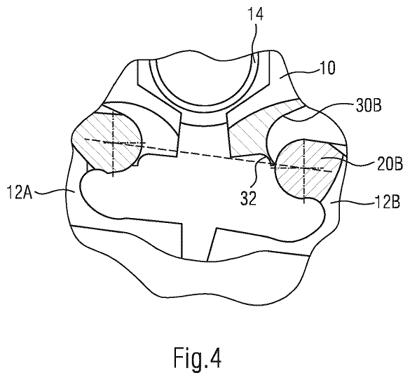

In a further embodiment shown in FIG. 4, a receptacle edge 32 is deformable. Due to the deformation of the receptacle edge, the second receptacle element 20B is deflected from the second receptacle 30B without resulting in a point load situation. Although this damages the pressing tool, it can prevent damage to the second connection element 20B and, in particular, the pressing device. The receptacle edge 32 is configured such that the force required to deform the receptacle edge 32 is less than a force that would damage the second connection element 20B.

Even if the present invention has been described above with reference to the second receptacle 30B, a deflector may also be provided on the first receptacle 30A, as is also shown in the figures. The function of the deflector on the first receptacle 30A can be similar or identical to the function of the deflector 33 on the second receptacle 30B. Similarly, the deflector on the first receptacle 30A and the deflector on the second receptacle 30B can be of identical design.

1. A pressing tool, in particular for pressing a workpiece by means of a pressing device, comprising
at least two segments movably connected to one another, wherein a first segment and a last segment each have a receptacle for receiving a connection element of a pressing device,
wherein at least one receptacle has a receptacle edge which delimits the receptacle,
wherein a deflector is arranged on the at least one receptacle so that the connection element is deflected from the receptacle edge.

2. The pressing tool according to claim 1, wherein the deflector is made of a different material than the segments.

3. The pressing tool according to claim 1, wherein the deflector is made of rubber or plastic.

4. The pressing tool according to claim 1, wherein the deflector is less hard than the connection element of the pressing device.

5. The pressing tool according to claim 1, wherein the deflector is plastically or elastically deformable.

6. The pressing tool according to claim 1, wherein the deflector is injection-molded, glued, screwed or clamped to the first and/or last segment.

7. The pressing tool according to claim 1, wherein the deflector has a deflector edge, wherein a line of action is located between the deflector edge of the first segment and a center of the receptacle of the last segment below the receptacle edge.

8. The pressing tool according to claim 1, wherein the deflector is displaceable, in particular in the direction of the pressing movement of the pressing device.

9. The pressing tool according to claim 1, wherein the deflector is arranged directly adjacent to the receptacle edge.

10. The pressing tool according to claim 1, wherein a surface of the deflector is aligned with an inner surface of the receptacle.

11. The pressing tool according to claim 1, wherein the deflector edge projects transversely beyond the receptacle edge.

12. The pressing tool according to claim 1, wherein the receptacle edge has a chamfer pointing away from the receptacle.

13. The pressing tool according to claim 1, wherein the deflector color-codes a nominal width of the pressing tool.

14. A pressing tool, in particular for pressing a workpiece by means of a pressing device, comprising
at least two segments movably connected to one another, wherein a first segment and a last segment each have a receptacle for receiving a connection element of a pressing device,
wherein at least one receptacle has a receptacle edge which delimits the receptacle,
wherein the receptacle edge is adapted to be deformed by the pressing device, wherein the connection element is deflected from the receptacle edge by the deformed receptacle edge.

15. The pressing tool according to claim 14, wherein the force for deforming the receptacle edge is less than a force for damaging the connection element of the pressing device.

16. The pressing tool according to claim 14, wherein the receptacle edge is deformed away from the receptacle.
